(19) United States
(12) Patent Application Publication
(10) Pub. No.: US 2004/0195395 A1
(43) Pub. Date: Oct. 7, 2004

(54) Method and apparatus for spray nozzle improvement through the use of surface and sub-surface coatings

(76) Inventor: Michael S. McLaughlin, Hudson Falls, NY (US)

Correspondence Address: FROMMER LAWRENCE & HAUG, 745 FIFTH AVENUE- 10TH FL., NEW YORK, NY, 10151, US

(21) Appl. No.: 10/688,662

(22) Filed: Oct. 17, 2003

Related U.S. Application Data
(63) Continuation-in-part of application No. 10/408,700, filed on Apr. 7, 2003.

(51) Int. Cl. B05B 1/00

(52) U.S. Cl. 239/589

(57) ABSTRACT

A method of forming and a spray nozzle for the application of liquids, powders and gasses, formed of a nozzle, an inlet orifice, an outlet orifice, a lumen connecting the inlet and outlet orifices, a land surface adjacent to the inlet orifice, and a plating impregnated with a lubricious material. The plating is impregnated with a lubricious material to prevent corrosion, scratching and build up of solids within the nozzle as well as to prevent galling from occurring when the nozzle includes a threaded section.

### RELATED APPLICATIONS

This application is a continuation-in-part of U.S. patent application Ser. No. 10/408,700 filed Apr. 7, 2003 and incorporated herein by reference.

### BACKGROUND OF THE INVENTION

1. Field of the Invention

The present invention relates, in general, to spray nozzles and in particular to a new and useful spray nozzle having a plating impregnated with a lubricious material for the prevention of galling, wear and corrosion, and methods of forming such a spray nozzle.

2. Description of the Related Art

Spray nozzles are used in various industries to apply liquids, powdered solids or gasses.

Liquids are often used to clean another surface and may include the application of chemicals. Regardless of the media being applied there is a constant problem of abrasion on and the adherence of solids to the nozzle surfaces. Additionally, it is possible that liquids or gasses could actually solidify on the nozzle. These occurrences have detrimental effect on the performance of the nozzle. Accordingly, there is a need for a nozzle that is resistant to abrasion and wear from chemicals and prevents the adherence of solids on the nozzle surfaces.

Current spray nozzles also suffer from issues regarding their ability to be changed when they are worn out, corroded, or simply dirty. Typically spray nozzles are formed of austenitic stainless steels. These steels provide for superior corrosion and abrasion resistance compared to other materials. However, when the nozzles are assembled into fittings of similar material, galling can occur between the mating surfaces. Galling is defined in MCGRAW-HILL DICTIONARY OF SCIENTIFIC AND TECHNICAL TERMS, 5^{th} ed. as surface damage on mating, moving metal parts due to friction caused by local welding of high spots. When galling occurs, the threads become unusable. This not only damages the nozzle that may be easily replaced, but also damages the machinery into which the nozzle is threaded. Such damage may limit the functionality of that machinery, require costly repairs, or render that piece of equipment unusable.

In an effort to combat some of the effects of the chemicals, in particular the solidification in the nozzle, some nozzles are used in conjunction with a rotating brush system. The rotating brush sweeps the back of the nozzle to remove the solids. However, in the process of sweeping out any solids, the brush often scratches the surface of the nozzle immediately adjacent the nozzle orifice. These scratches can negatively alter the flow pattern of the fluid and therewith the performance and effective life of the nozzle.

One method of combating the scratching is to use a nozzle assembly 103 including ceramic or jewel (ruby, sapphire, etc.) inserts 120 as shown in FIGS. 7 and 8. The nozzle insert 120 has an orifice 132 that allows for the egress of fluid. The nozzle assembly 103 includes jewel inserts 120 requiring a gasket 122, and a retaining nut 124. The retaining nut 124 holds the jewel insert against the gasket 122, all of which are threaded into and secured in the nozzle base 126. The nozzle base 126 is typically welded to a spray device.

While these jewel inserts 120 are resistant to scratching themselves and prevent scratches immediately adjacent to the orifice 130 of the nozzle base 126, scratches in the metal surface 128 surrounding the insert 120 still negatively impact nozzle performance and effective life of the nozzle assembly 103. Another disadvantage of this assembly is the requirement for additional parts that must be periodically replaced and over time may no longer seat properly in the assembly.

Accordingly, there is a need for a nozzle that will resist damage, scratching, and clogging along with the effects of galling and enable a mechanic to easily replace a worn or dirty nozzle without threat of damaging the equipment and that reduces the number of parts necessary for replacement during routine maintenance.

### SUMMARY OF THE INVENTION

The present invention relates to a spray nozzle comprising, a housing, an inlet orifice, an outlet orifice, a lumen connecting the inlet and outlet orifices, and a lubricious plating. The lubricious plating may include nickel, titanium nitride, titanium carbonitride, titanium aluminum nitride, chromium nitride, zirconium nitride, black oxide and modified tungsten disulfide and other metal and non-metal materials. The lubricious plating is preferably impregnated with PTFE or other lubricating material. The housing may be formed of stainless steel and have threads which may also be coated with the lubricious plating.

The present invention also relates to a method of preventing galling and corrosion in a spray nozzle. The steps include providing a spray nozzle and plating the spray nozzle. Preferably the plating is impregnated with a lubricating material. The lubricating material may be PTFE. The plating may include nickel, titanium nitride, titanium carbonitride, titanium aluminum nitride, chromium nitride, zirconium nitride, black oxide and modified tungsten disulfide and other metal and non-metal materials.

The various features of novelty which characterize the invention are pointed out in particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 depicts a front perspective view of a nozzle.

FIG. 2 depicts a bottom view of the nozzle of FIG. 1.

FIG. 3 depicts a cross sectional view of the nozzle, cut along line 3-3.

FIG. 4 depicts a spray device of the prior art having a nozzle inserted therein;

FIG. 5 depicts a close-up view of the nozzle of FIG. 4 cut along line 5-5;

FIG. 6 depicts a bottom view of the nozzle of FIG. 4 having a land surface;

FIG. 7 depicts an exploded view of the components of a nozzle having a jewel insert of the prior art; and

FIG. 8 depicts a cross-sectional view of the prior art nozzle of FIG. 7.

### DESCRIPTION OF THE PREFERRED EMBODIMENTS

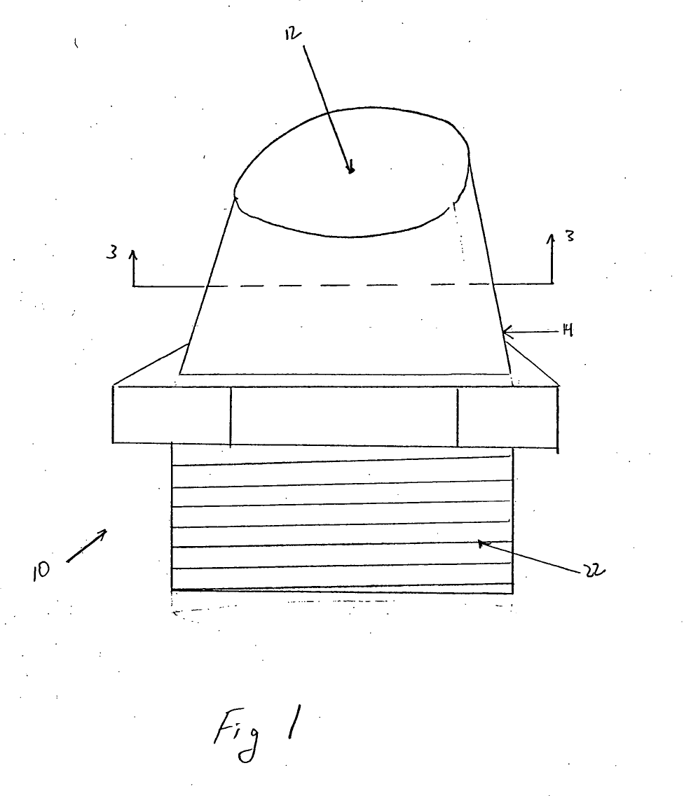

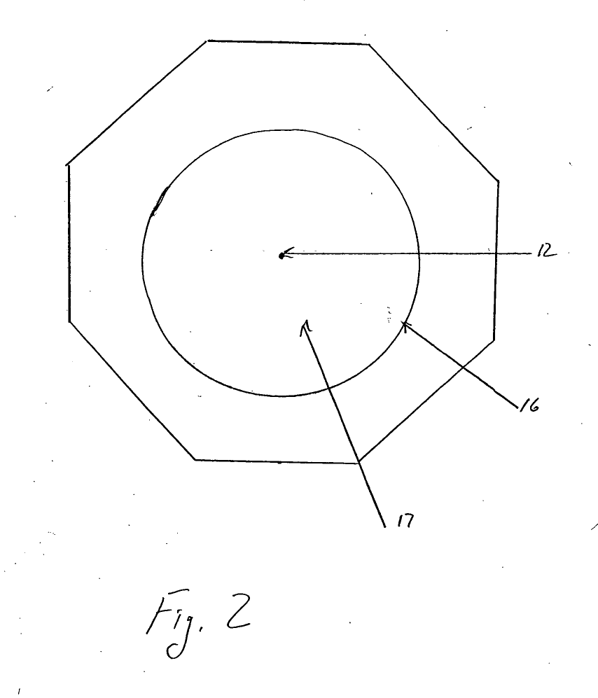

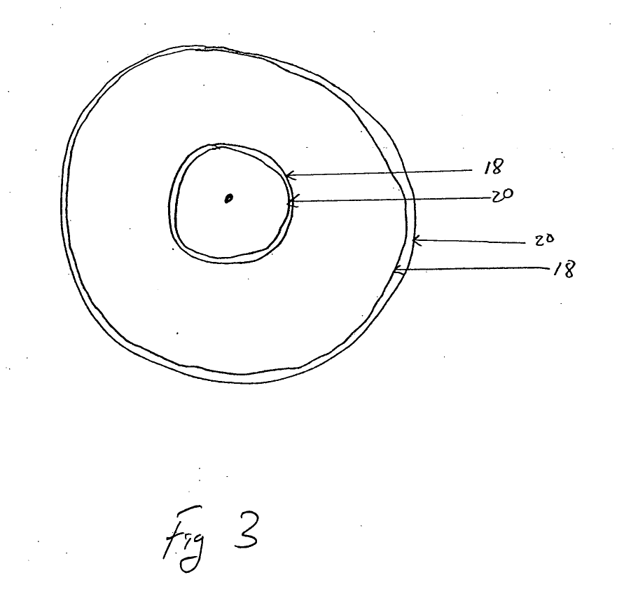

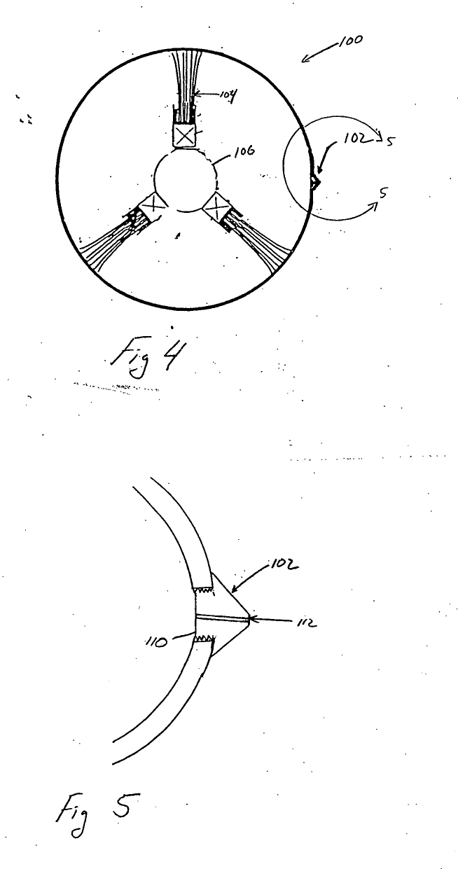

Referring now to the figures, a spray nozzle 10 is provided including a body 14, an inlet orifice 16, an outlet orifice 12, and a lumen 17 connecting the inlet and outlet orifices. The entire spray nozzle 10 is plated with a plating material 20. It is preferable that the nozzle 10 includes threads 22, as shown in FIG. 1. Further, it is preferable that the nozzle 10 is formed of a stainless steel, although other materials may be used without departing from the scope of this invention.

The nozzle 10 is preferably attached via the threads 22 to a delivery device (not shown) which supplies a material to be sprayed by the nozzle 10. The material enters the inlet orifice 16, passes through the lumen 17, and exits the outlet orifice 12. The materials that are passed through the nozzle may include liquids, solids, slurries, and gasses.

Because these materials often contain chemicals that are corrosives, or the materials themselves may be abrasive and cause erosion, the nozzle is preferably coated or plated with a material such as nickel. Other materials which may be used include but are not limited to titanium nitride, titanium carbonitride, titanium aluminum nitride, chromium nitride, zirconium nitride, black oxide, modified tungsten disulfide and other metal and non-metal materials.

Additionally, the plating is impregnated with a lubricious material. One example of a lubricious material is Polytetrafluoroethylene (PTFE). Other materials may be substituted for PTFE without departing from the scope of this invention. The impregnation of the lubricious material into the plating metal acts to prevent many of the corrosive and abrasive effects of forcing a material through a nozzle 10.

The plating with the impregnated lubricious material of the lumen 17, the inlet orifice 16, and the outlet orifice 12 works to eliminate much of the corrosive and abrasive effects of the materials which pass there through. Additionally, the PTFE impregnation of the plating works to prevent the build up of solids on the interior surfaces of the lumen 17. Often these solid deposits form and can act to plug the nozzle 10 by plugging orifice 12. Further, these deposits can lead to localized pitting due to the corrosive nature of the solid or localized erosion within the nozzle. The pitting could further result in damage to the threads of the delivery device.

The plating with the impregnated lubricious material of the threads 22 of the nozzle 10 has the beneficial effect of limiting galling of the threads. As described above, galling results in the destruction of the threads and local welding. While this may or may not effect the life of the individual nozzle, the effects of galling on the delivery device can be catastrophic, resulting in down time or possible scrapping of the entire device. Galling is typically prevented by the isolation of similar metals by a dissimilar metal. Accordingly, the plating of the threads with nickel or other material as described herein prevents galling. Further, the lubricious nature of a material such as PTFE allows for smoother and easier insertion and removal of the nozzle 10 from the delivery device.

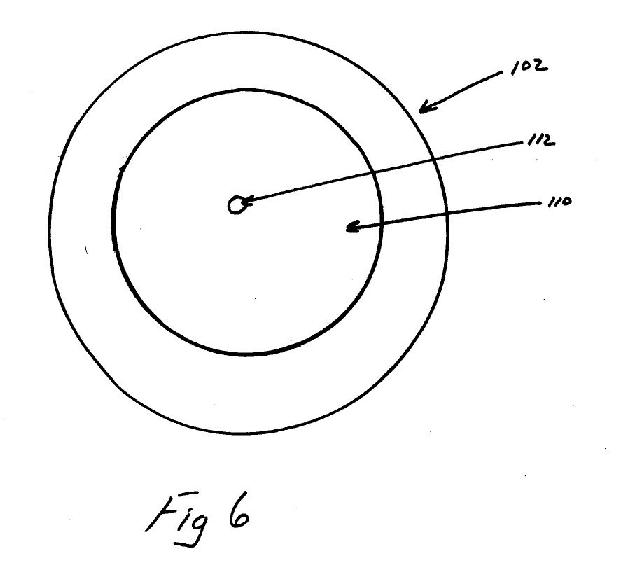

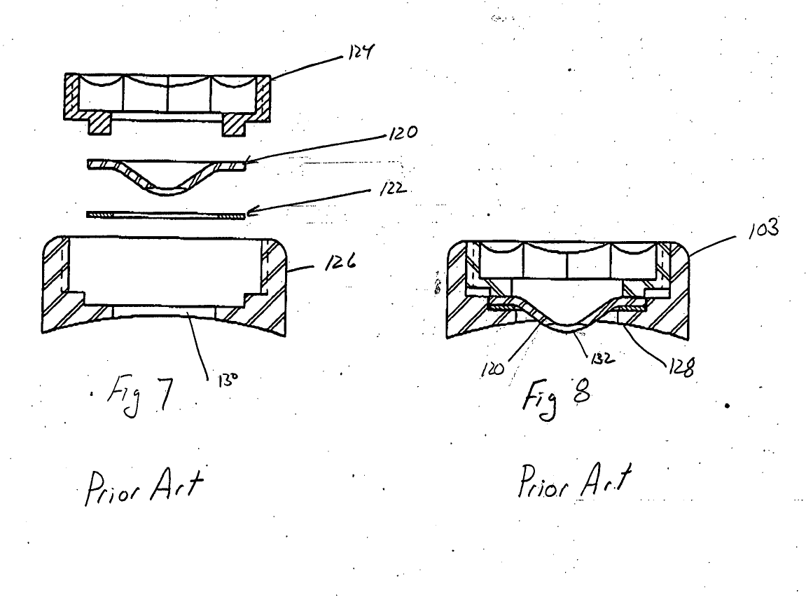

According to another aspect of the present invention, in applications where scratching and wear due to brushes is a concern, the entire nozzle can be coated. FIG. 4 shows a the nozzle 102 inserted into a device 100 having brushes 104 mounted on a rotatable rod 106. The brushes may be made of a material of sufficient hardness to scratch the nozzle 102, and in particular the orifice 112, and the land surface 110. FIG. 6 shows a bottom view of a nozzle 102 according to one embodiment of the present invention having an orifice 112 and a land surface 110.

In practice the rod 106 rotates causing the brushes 104 to scrape along the interior surface of the device 100. In so doing the brushes 104 also scrape along a land surface 110 and the orifice 112 of the nozzle 102. In an uncoated nozzle, this movement of the brushes leads to scratching of the land surface 110 and the orifice 112. As a result the uncoated nozzle suffers from reduced efficiency and can experience corrosion and deposit problems over time.

To prevent scratching, the land surface 110 may be plated with a hard corrosion resistant metal such as nickel or other material as described herein. The metal may also be impregnated with a lubricious material such as PTFE or other lubricious materials as described herein. The hardness of the nickel material prevents scratches from forming in land surface 110 and the orifice 112. In addition, the lubricious nature of a material such as PTFE allows for reduced brush wear as the brushes are drawn across the land surface 110. In a further embodiment, the entire nozzle 102 may be nickel plated, and may be impregnated with a lubricious material.

While the invention has been described in connection with what is considered to be the most practical and preferred embodiment, it should be understood that this invention is not limited to the disclosed embodiments, but on the contrary, is intended to cover various modifications and equivalent arrangements included within the spirit and scope of the appended claims.

What is claimed is:

1. A method of preventing scratching of a land surfaces of a spray nozzle comprising the steps of:
providing a spray nozzle having a land surface; and
plating the land surface of the spray nozzle with a material, wherein the material is impregnated with a lubricating material.

2. The method as recited in claim 1, wherein the material is nickel.

3. The method as recited in claim 1, wherein the lubricating material is PTFE.

4. The method as recited in claim 1, wherein the material is one selected from the group consisting of titanium nitride, titanium carbonitride, titanium aluminum nitride, chromium nitride, zirconium nitride, black oxide and modified tungsten disulfide.

5. The method as recited in claim 1, wherein the spray nozzle is formed of a stainless steel.

6. The method as recited in claim 1, wherein the spray nozzle comprises a threaded portion.

7. The method as recited in claim 1, wherein the spray nozzle is a liquid spray nozzle.

8. A spray nozzle comprising:
a housing;
an inlet orifice;
an outlet orifice;
a lumen connecting the inlet and outlet orifices;
a land surface adjacent the inlet orifice; and
a lubricious plating formed at least on said land surface.

9. The spray nozzle of claim 8, wherein the lubricious plating is formed of a material having wear resistance, scratch resistance, anti-galling, and anti-adhesion properties.

10. The spray nozzle of claim 8, wherein the lubricious plating is formed of nickel.

11. The spray nozzle of claim 10, wherein the lubricious plating is impregnated with PTFE.

12. The spray nozzle of claim 8, wherein the lubricious plating is selected from the group consisting of titanium nitride, titanium carbonitride, titanium aluminum nitride, chromium nitride, zirconium nitride, black oxide and modified tungsten disulfide.

13. The spray nozzle of claim 12, wherein the lubricious plating is impregnated with PTFE.

14. The spray nozzle of claim 8 formed of a stainless steel.

15. The spray nozzle of claim 8, wherein the housing includes a portion having threads thereon.

16. The spray nozzle of claim 15, wherein the threads are plated with the lubricious coating.

17. An improved spray nozzle of the type having a housing, an inlet orifice, an outlet orifice, a lumen connecting the inlet and outlet orifices and a land surface adjacent the inlet orifice, wherein the improvement comprises a lubricious plating formed on at least said land surface.

18. The spray nozzle of claim 17, wherein the lubricious plating is formed of a material having wear resistance, scratch resistance, anti-galling, and anti-adhesion properties.

19. The spray nozzle of claim 17, wherein the lubricious plating is formed of nickel.

20. The spray nozzle of claim 19, wherein the lubricious plating is impregnated with PTFE.

21. The spray nozzle of claim 17, wherein the lubricious plating is selected from the group consisting of titanium nitride, titanium carbonitride, titanium aluminum nitride, chromium nitride, zirconium nitride, black oxide and modified tungsten disulfide.

22. The spray nozzle of claim 21, wherein the lubricious plating is impregnated with PTFE.

23. The spray nozzle of claim 17 formed of a stainless steel.

24. The spray nozzle of claim 17, wherein the housing includes a portion having threads thereon.

25. The spray nozzle of claim 24, wherein the threads are plated with the lubricious coating.
